(19) United States
(12) Patent Application Publication
(10) Pub. No.: US 2017/0001295 A1
(43) Pub. Date: Jan. 5, 2017

(54) A DOUBLE-END PLIER

(71) Applicant: SHANGHAI EASY-USE TOOLS ENTERPRISE CO., LTD., Shanghai (CN)

(72) Inventor: Shiyu Sun, Shanghai (CN)

(73) Assignee: SHANGHAI EASY-USE TOOLS ENTERPRISE CO., LTD., Shanghai (CN)

(21) Appl. No.: 15/102,405

(22) PCT Filed: Jun. 26, 2014
(86) PCT No.: PCT/CN2014/080797

§ 371 Date: Jun. 7, 2016

(30) Foreign Application Priority Data
Nov. 13, 2013 (CN) 201310566354.8

(51) Int. Cl. B25F 1/00; B25F 1/04; B25B 7/22

(52) U.S. Cl. CPC B25F 1/003; B25B 7/22; B25F 1/04

(57) ABSTRACT

This invention relates to a double-end pliers, including the handles and the tong heads, wherein the tong heads include the first tong head and the second tong head, wherein the handles include the spindle, first handle and second handle, wherein the tong first tong head and second tong head are connected with the handles via two kinds of connecting methods, wherein the tong head connects with the first handle, wherein the tong head is connected via two horizontal connecting shafts to the shaft and spindle, wherein the first tong head and the second tong head rotate longitudinally to roll separate horizontal connecting shafts in to make the tong head fold or expand, wherein the first handle and second handle separately create the gripping force against the first tong head and the second tong head with the spindle.

### TECHNICAL FIELD

This invention is directed, in general, to hardware tools and, more specifically, to a double-end pliers.

### BACKGROUND

The pliers are a common tool in life and work. Traditional pliers have a single function, and usually include a handle and one tong head used to grip an object. However, while traditional pliers have a gripping function, they cannot cut objects. In addition, the tong heads and the handle of traditional pliers cannot be folded together. Consequently, these pliers take up an unnecessary amount of space and are aesthetically unattractive.

### SUMMARY OF THE INVENTION

To address the above-discussed deficiencies of the prior art, it is the primary object of the present invention to provide a double-end pliers comprising a handle and a tong head.

The tong head comprises a first tong head and a second tong head, as well a handle comprising a spindle, and a first handle and a second handle.

According to one advantageous embodiment of the present invention, the first tong head and the second tong head separately connect two ends of the spindle via a connecting shaft. The spindle is connected to the first handle via the first tong head, and the spindle is connected via a first hinge axis and a second handle via the second tong head and the second hinge axis. The spindle interacts with the first handle to create the gripping force against the first tong head. Further, the spindle interacts with the second handle to create a gripping force against the second tong head.

According to one embodiment of the present invention, the first tong head and the second tong head are able to rotate horizontally in the direction of the spindle and the connecting rolling shafts located at two ends of the spindle.

According to another embodiment of the present invention, the first handle is able to rotate horizontally in the direction of the first tong head and the connecting rolling shaft located between the first handle and the first tong head. Additionally, the second handle is able to rotate horizontally in the direction of the second tong head and the connecting rolling shaft between the second handle and the second head.

According to another embodiment of the present invention, each of the two ends of the spindle, the connecting end of the first handle, and the connecting end of the second handle are equipped with card slots, which are used to place the tong heads.

According to another embodiment of the present invention, each of the spindle, the first handle, and the second handle are equipped with corresponding cavities within the tong head.

According to another embodiment of the present invention, each of the first tong head and the second tong head are equipped with springs located at the middle of rear part.

According to another embodiment of the present invention, the first spindle is equipped with column (12) at inside of middle part, corresponding, aforesaid first handle (4) and second handle II (5) are equipped with grooves (13) at inside of middle part which are matched with aforesaid column (12).

According to another advantageous embodiment of the present invention, the tong head comprises the first tong head and the second tong head. Further, the handle comprises the spindle, the first handle, and the second handle. The first tong head and the second tong head are separately connected at the two ends of the spindle via clipping a first union piece and clipping a second union piece. The spindle is connected to the first handle via the first tong head and the first hinge axis, and the spindle is connected to the second handle via the second tong head and the second hinge axis. The spindle is interconnected to the first handle to create the gripping force against the first tong head; and, the spindle is interconnected to the second handle to create the gripping force against the second tong head.

According to another embodiment of the present invention, the spindle is equipped with column (12) at inside of middle part, and wherein each of the first handle and the second handle are comprised of grooves located at the center of the first handle and the second handle. The grooves located at the center of the first handle and the second handle correlate to column 12.

According to another embodiment of the present invention, there is a tong head and a spindle. The tong head comprises a first tong head and a second tong head, wherein the spindle comprises an “S” structure. The inside of the spindle's two ends are separately connected with the first tong head and the second tong head via horizontal connecting shafts. The other end of the first tong head comprises a horizontal connecting shaft that is connected with the first handle, and the other end of the second tong head comprises a horizontal connecting shaft that is connected with the second handle. There is a space suitable for the shape of the first tong head between the spindle and the first handle. Also, there is space suitable for the shape of the first tong head to place it between the spindle and second handle, and there is space suitable for the shape of the second tong head.

According to another embodiment of the present invention, the spindle and the first handle vertically rotate the horizontal connecting shaft of the first tong head, and the spindle and second handle vertically rotate the horizontal connecting shaft of the first tong head.

According to another embodiment of the present invention, the spindle, the first handle, the second handle, and the tong head are equipped with shoulders at the end of the rear part.

The double-end pliers, according to any item is characterized in that: aforesaid tong head is cutting pliers, incision pliers, bolt cutters, wire stripper, nutcracker, ring washer pliers, circlip pliers, nail puller, electrician's pliers, metal cutting pliers, glass clamp, fencing pliers, battery clamps, gas pliers, end cutting pliers, nipper pliers, nose pliers or scissors.

The present invention offers a variety of functions and is easy to use. The tong head can be folded into the handle, which is functional and convenient, as well as aesthetically pleasing relative to traditional pliers.

### BRIEF DESCRIPTION OF THE DRAWINGS

For a more complete understanding of the present invention, and the advantages thereof, reference is now made to the following descriptions taken in conjunction with the accompanying drawings, wherein like numbers correspond to like objects, and in which:

FIG. 1 is a structure diagram of a double-end pliers according to one embodiment of the present invention.

FIG. 2 is an amplifying structure diagram of a spindle according to one embodiment of the present invention.

FIG. 3 is an amplifying structure diagram of a card slot according to one embodiment of the present invention.

FIG. 4 is a structure diagram comprising a tong head according to one embodiment of the present invention.

FIG. 5 is a structure diagram of the folding mechanism according to one embodiment of the present invention.

FIG. 6 is a diagram of a double-end pliers according to one embodiment of the present invention.

FIG. 7 is a structure diagram of a double-end pliers according to one embodiment of the present invention.

FIG. 8 is a structure diagram of a double-end pliers according to one embodiment of the present invention.

FIG. 9 is a structure diagram of the folding mechanism according to one embodiment of the present invention.

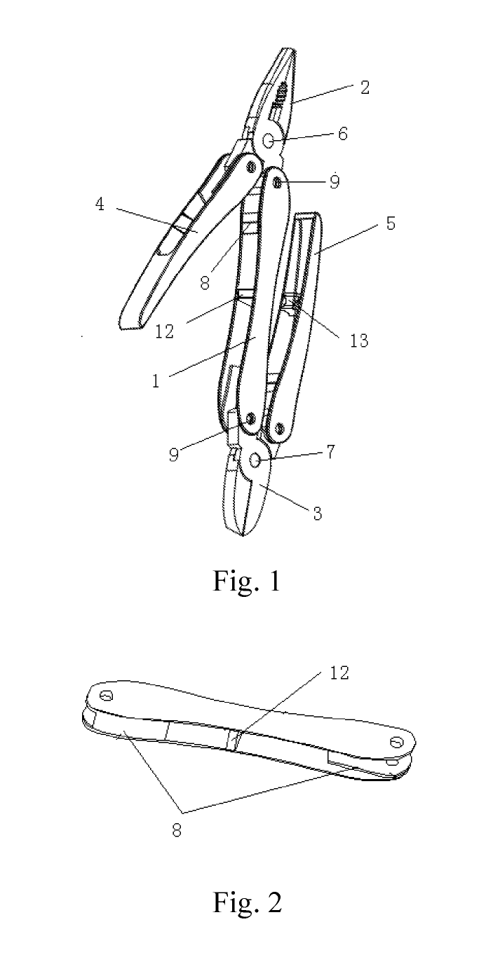

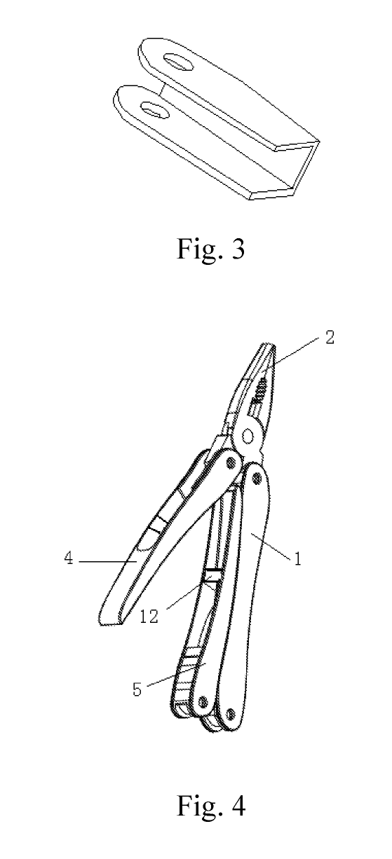

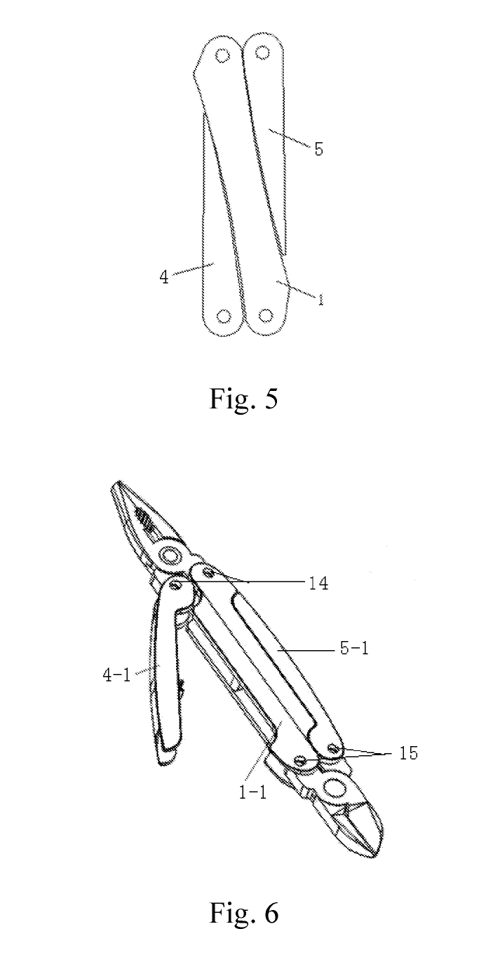

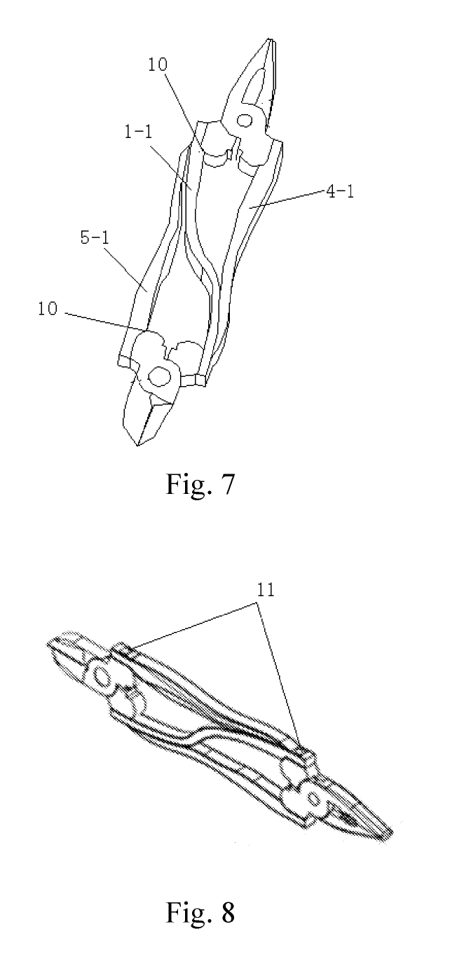

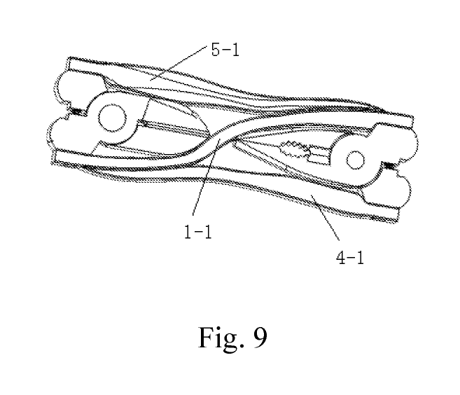

In the figure:

1. The spindle; 2 first tong head; 3 second tong head; 4 first handle; 5. second handle; 6. First hinge axis; 7 second hinge axis; 8. Card slot; 9. Connecting shaft; 10. Retaining shoulder; 11. Transverse connecting shaft; 12 column; 13. Groove; 14. First card union piece; 15. Second clipping union piece; 1-1. The spindle; 4-1 Handle; 5-1, second handle; 1-2. The spindle; 4-2 first Handle; 5-2 second handle

### DETAILED DESCRIPTION OF THE INVENTION

Below are the embodiments of the present invention:

### Embodiment 1

The double-end pliers apparatus comprising a handle and tong head. The tong head comprises a first tong head 2 and a second tong head 3. The handle includes the first spindle, the first handle 4 and the second handle 5. The first tong head and the second tong head connects the two ends of the said spindle via the connecting shaft 9. The second spindle is connected to the first handle via the tong head and the first hinge axis 6 and through the second tong head 3 and the second hinge axis 7 to connect to a second handle 5. The first handle 4 and second handle 5 are placed on both sides of the first spindle and are used in conjunction with the first spindle. The first spindle combines with the first handle 4 to form the gripping force of the second tong head 2, and the first spindle combines with the second handle 5 to form the gripping force of the second tong head 3.

The first tong head 2 and second tong head 3 rotate horizontally along the spindle's direction that rolling connecting shaft 9 of the ends of the first spindle. The rotation angle ensures that the tong head can keep a horizontal line with the first spindle so that tong head can easily close within the cavity of the first spindle, or stretch out from the cavity of the first spindle. The first tong head 4 and first tong head 2 can rotate horizontally along the first tong head's 2 direction that rolls its clamp connecting shaft 9 with the first tong head 2. The angle of rotation shall ensure the first handle 4 is closely stowed on the side of the first spindle after packing up. The second handle can rotate horizontally along the second tong head's 3 direction that rolls its connecting shaft 9 with the second tong head 3 so that the second handle 5 is closely stowed on the side of the first spindle after packing up. The rotation angle of both is appropriate when the first handle 4 and second handle 5 can smoothly rotate to the two sides of the first spindle. Both ends of the first spindle, the connecting end of the first handle 4 and the connecting end of the second handle 5 are all set with card slot 8 to install the tong head. The inside of the slot 8 is provided with a stopper, so that when the tong head is placed into the cavity of the handle, it can just block the inward rotation of the tong head. The inside of spindle 1, the first handle 4 and second handle 5 is provided with a cavity for receiving the tong head, and the tong head can be set in the cavity of the handle when packing up.

The tail in the middle of the said first tong head 2 and the second tong head 3 are set with a spring. The spring is mainly to relieve stress impact during the use of the tong head, while the gripping force can be more firmly grasped during use so that the pliers can more firmly grip the object. The inner medium side of the spindle 1 is provided with column 12, the inner medium side of the first handle 4 and the second handle 5 are set with slot 13 that corresponds to column 12. The column 12 and slot 13 are snap-fit when the said handle and the spindle 1 are packed up so that the handle is secure.

During the use, the first tong head 2 can be mounted to wire cutters, while the second tong head 3 is mounted to cutting nippers. When you need to use a wire cutters head, you can open the first handle 4, then rotate the first tong head 2 into the proper position. Then patch up the other end of the second handle 5 of spindle 1, then you can hold the first handle 4 to force to the first tong head 2. When you need to use the cutting pliers head, you can open the second handle 5, then rotate the second tong head 3 into proper position. Then patch up the other end of the first handle 4 of the first spindle, then you can hold the second handle 5 to force the second tong head 3. When you need to carry, you can patch up the first handle 4 and second handle 5 of the ends of the first spindle and first tong head 2 as well as the second tong head 3. The tong head shall be set in the cavity of the handle and can be folded together, so it is easy to carry, aesthetically attractive, and compact.

### Embodiment 2

The tong head includes a first tong head 2 and second tong head 3, and the handle includes a spindle 1-1, 4-1 and a handle 4-1 and the second handle 5-1. The first tong head 2 and second tong head 3 connects to the two ends of spindle via clipping the first union piece 14 and the second clipping union piece 15. The said spindle 1-1 through the first tong head and hinge axis to connect the handle 4-1, and through the second tong head 3 and second hinge axis 7 to connect the second handle 5-1. The said spindle 1-1 and handle 4-1 coordinate to form the gripping force to the first tong head 2, and the said spindle 1-1 and second handle 5-1 to form the gripping force to the second tong head 3. The central inner side of the spindle 1-1 has set a column 12, the central inner side of the said handle 4-1 and second handle 5-1 shall be set with slot 13 that corresponds with column 12.

During use, the tong head can be installed according to specifications and models. The first handle 4-1 connects to the spindle 1-1 via the first clipping union piece 14. After opening, the first handle 4-1 interacts with spindle 1-1, and the first handle 4-1 can not be rotated in the first tong head's 2 connection. Similarly, the second handle 5-1 connects to the spindle 1-1 via clipping the second union piece 15. After opening, the handle cooperate with the spindle 1-1, and the second handle 5-1 cannot be rotated at the connection with the second tong head 3. When you do not use the tong head of one end of spindle 1-1, and the unused handle are folded up by the cooperation of its slot 13 and the stand column 12.

### Embodiment 3

The double-end pliers apparatus is including the tong head and the spindle, is characterized in that the tong head includes the first tong head 2 and the second tong head 3, the aforesaid spindle 1-2 is in S structure. The inside of the aforesaid spindle's (1-2) two ends are separately connected with the first tong head 2 and the second tong head 3 via horizontal connecting shafts 11; the other end of the first tong head's 2 horizontal connecting shaft's 11 is connected with the first handle (4-2), the other end of the second tong head 3 horizontal connecting shaft's 11 is connected with the second handle (5-2), between aforesaid spindle 1 and the first handle 4-2, there is space suitable for the shape of the first tong head 2 to place it, between aforesaid spindle (1-2) and second handle (5-2), there is space suitable for the shape of the second tong head 3 to place it. Space size in addition to ensuring a smooth place of the tong head, it should leave a space to set for fingers to facilitate the rotation of the tong head between spindle 1-2 and the handle. The first spindle 1-2 and first handle can rotate the first tong head I 2′s horizontal connecting shaft 11 to rotate vertically. The said spindle 1-2 and second handle (5-2) can rotate the second tong head 3's horizontal connecting shaft 11 to make vertical rotation. The angle of rotation must be at least 180 degrees in order to ensure the tong head can be stretched out and folded up when relative to space.

The aforesaid spindle 1-2, first handle (4-2), second handle (5-2) and tong head are equipped with shoulders 10 at the end of rear part, and the shoulder can block the two large openings of the pliers during for easy use. The tail in the middle of the first tong head 2 and second tong head 3 are set with a spring. The spring is mainly to relieve stress impact during the use of tong head, while the gripping force can be more firmly grasped during use so that the pliers can more firmly grip the object.

During use, the first tong head 2 can be installed as nipper pliers, and the second tong head 3 can be installed as diagonal cutting nippers. When using the nipper pliers, you can rotate 180 degrees of the spindle 1-2 and first handle (4-2) that the tong head. The first tong head 2 and the spindle 1-2 and first handle (4-2) is in a horizontal position. And patch the tong head within the space of the second tong head 3 of spindle 1-1 and the second handle (5-2). Then you can through the spindle 1-2 and first handle (4-2) to make gripping force to the first tong head 2 for operation.

The tong head of the double-end pliers of the present invention may include wire cutters, cut pliers, bolt cutters, wire strippers, nutcracker, stalls circle clamp, circlip pliers, nails pliers, electrical pliers, white pincers, glass pliers, wire networking tool, battery clamp, gas pipe wrench, top cut pliers, needle nose pliers, diagonal pliers or scissors. But it is not limited to the several tong heads, which can be designed according to user needs.

Having described this invention in detail, those skilled in the art will appreciate that numerous modifications may be made of this invention without departing from the spirit of the invention. Therefore, it is not intended that the breadth of the invention be limited to the specific embodiments illustrated d described. Rather, the scope of the invention is to be determined by appended claims and their equivalents.

1. A double-end pliers apparatus comprising:
a first tong head and a second tong head;
a handle comprising a spindle, a first handle and a second handle;
wherein the first tong head and the second tong head separately connect two ends of the spindle via a connecting shaft; wherein the spindle is connected to the first handle via the first tong head; wherein the spindle is connected via a first hinge axis and a second handle via the second tong head and the second hinge axis; wherein the spindle interacts with the first handle to create the gripping force against the first tong head; the spindle interacts with the second handle to create the gripping force against the second tong head.

2. The double-end pliers according to claim 1, wherein the first tong head and the second tong head are able to rotate horizontally in the direction of the spindle and the rolling connecting shafts located at two ends of the spindle.

3. The double-end pliers according to claim 2, wherein the first handle is able to rotate horizontally in the direction of the first tong head and the rolling connecting shaft located between the first handle and the first tong head; and, the second handle is able to rotate horizontally in the direction of the second tong head rolling the connecting shaft between the second handle and the second head.

4. The double-end pliers according to claim 3, wherein each of the two ends of the spindle, the connecting end of the first handle, and the connecting end of the second handle are equipped with card slots, which are used to place the tong heads.

5. The double-end pliers, according to claim 4, wherein each of the spindle, the first handle, and the second handle are equipped with cavities, which are matched within the tong head.

6. The double-end pliers, according to claim 5, wherein each of the first tong head and the second tong head are equipped with springs located at the middle of rear part.

7. The double-end pliers, according to claim 6, wherein the first spindle is equipped with column at inside of middle part, corresponding, aforesaid first handle and second handle are equipped with grooves at inside of middle part which are matched with aforesaid column.

8. The double-end pliers, according to claim 1, wherein the tong head comprises the first tong head and the second tong head; and wherein, the handle comprises the spindle, the first handle, and the second handle; wherein the first tong head and the second tong head are separately connected at the two ends of the spindle via clipping a first union piece and clipping a second union piece; wherein the spindle is connected to the first handle via the first tong head and the first hinge axis, and the spindle is connected to the second handle via the second tong head and the second hinge axis; and, wherein the spindle interconnected to the first handle to create the gripping force against the first tong head; and, the spindle is interconnected to the second handle to create the gripping force against the second tong head.

9. The double-end pliers, according to claim 8, wherein the spindle is equipped with column at inside of middle part, and wherein each of the first handle and the second handle are comprised of grooves located at the center of the first handle and the second handle; and wherein the grooves located at the center of the first handle and the second handle correlate to column.

10. A double-end pliers apparatus, comprising:
a tong head and a spindle, wherein the tong head comprises a first tong head and a second tong head, wherein the spindle comprises an “S” structure, and wherein the inside of the spindle's two ends are separately connected with the first tong head and the second tong head via horizontal connecting shafts, and wherein the other end of the first tong head comprises a horizontal connecting shaft that is connected with the first handle, and wherein the other end of the second tong head comprises a horizontal connecting shaft that is connected with the second handle, and wherein there is a space suitable for the shape of the first tong head between the spindle and the first handle, and there is space suitable for the shape of the first tong head to place it between aforesaid spindle and the second handle, and there is space suitable for the shape of the second tong head.

11. The double-end pliers, according to claim 10, wherein the spindle and the first handle vertically rotate the horizontal connecting shaft of the first tong head, and wherein the spindle and second handle vertically rotate the horizontal connecting shaft of the first tong head.

12. The double-end pliers, according to claim 11, wherein the spindle, the first handle, the second handle, and the tong head are equipped with shoulders (10) at the end of the rear part.

13. The double-end pliers, according to any item of claim 12, is wherein in that: aforesaid tong head is cutting pliers, incision pliers, bolt cutters, wire stripper, nutcracker, ring washer pliers, circlip pliers, nail puller, electrician's pliers, metal cutting pliers, glass clamp, fencing pliers, battery clamps, gas pliers, end cutting pliers, nipper pliers, nose pliers or scissors.
